(19) United States
(12) Patent Application Publication
(10) Pub. No.: US 2017/0100792 A1
(43) Pub. Date: Apr. 13, 2017

(54) METHOD FOR MANUFACTURING A STRIKING PLATE FOR A GOLF CLUB HEAD

(71) Applicant: ADVANCED INTERNATIONAL MULTITECH CO., LTD., KAOHSIUNG CITY (TW)

(72) Inventors: CHEN-KUO HUANG, KAOHSIUNG CITY (TW); YUAN-JEN HOU, KAOHSIUNG CITY (TW); WEN-YUAN WANG, KAOHSIUNG CITY (TW)

(21) Appl. No.: 15/019,303

(22) Filed: Feb. 9, 2016

(30) Foreign Application Priority Data
Oct. 7, 2015 (TW) 104133055

(51) Int. Cl. B23H 3/04; A63B 53/04

(52) U.S. Cl. CPC B23H 3/04; A63B 53/047; A63B 2053/0416

(57) ABSTRACT

A method for manufacturing a striking plate for a golf club head includes the steps of: providing a metal blank plate having a surface which includes a plurality of first machining zones displaced from each other by a corresponding one of a plurality of second machining zones, machining the first machining zones of the metal blank plate using a precise electrochemical machining device, and machining the second machining zones using the precise electrochemical machining device.

### CROSS-REFERENCE TO RELATED APPLICATION

This application claims priority of Taiwanese Application No. 104133055, filed on Oct. 7, 2015.

### FIELD

The disclosure relates to a method for manufacturing a striking plate for a golf club head.

### BACKGROUND

A conventional golf club head is primarily made from a titanium alloy or tungsten carbide due to such characteristics as light weight and stiffness of these materials. The golf club head thus made has an enhanced spring-like effect, and thus can achieve a relatively long flying distance before landing.

In addition to modifying the materials for the golf club head, it would also be desirable to modify the configuration of the golf club head so as to improve striking controllability.

In order to enhance the striking controllability, a golf club head 1 as shown in FIG. 1 has been produced. The golf club head 1 includes a striking plate 11 formed with a plurality of linear grooves 111 spaced apart from each other.

The linear grooves 111 of the striking plate 11 are generally formed using a mechanical process such as casting or forging. However, the precision of the linear grooves 111 of the striking plate 11 formed by the casting or forging process is inferior, and thus it is necessary to perform several additional processing procedures to obtain a finished product.

In view of the precision problem encountered in the casting or forging process, a milling process is used for forming the linear grooves 111 of the striking plate 11 instead. Although the precision of the linear grooves 111 of the striking plate 11 may be increased using the milling process, the processing time may be increased if the linear grooves 111 of the striking plate 11 to be formed are very small or are large in number.

Furthermore, it is still necessary to perform further treatment to eliminate thermal or mechanical stress from the striking plate 11 after the casting, forging or milling process.

### SUMMARY

Therefore, an object of the disclosure is to provide a method for manufacturing a striking plate for a golf club head to enhance the precision of the striking plate thus manufactured while reducing the processing time and cost.

A method for manufacturing a striking plate for a golf club head according to the disclosure includes the steps of:

providing a metal blank plate having a surface which includes a plurality of first machining zones displaced from each other in a first direction by a corresponding one of a plurality of second machining zones, each of the first machining zones being intended to be formed with a first shaped area having a plurality of parallel linear protrusions which are displaced from each other in the first direction by a predetermined distance and which extend in a second direction perpendicular to the first direction, each of the second machining zones being intended to be formed with a second shaped area having a linear groove extending in the second direction;

machining the first machining zones of the surface of the metal blank plate using a precise electrochemical machining device which includes, as a cathode, a first template having a plurality of linear recess portions complementary in shape to the parallel linear protrusions to be formed in the first machining zones of the metal blank plate that acts as an anode to thereby obtain a semi-finished product formed with the parallel linear protrusions; and

machining the semi-finished product, which acts as the anode, using the precise electrochemical device with the first template replaced by a second template that acts as the cathode and that has a protrusion portion complementary in shape to the linear groove to be formed in each of the second machining zones to thereby obtain the striking plate.

### BRIEF DESCRIPTION OF THE DRAWINGS

Other features and advantages of the disclosure will become apparent in the following detailed description of the embodiment with reference to the accompanying drawings, of which:

FIG. 1 is a side view of a conventional golf club head;

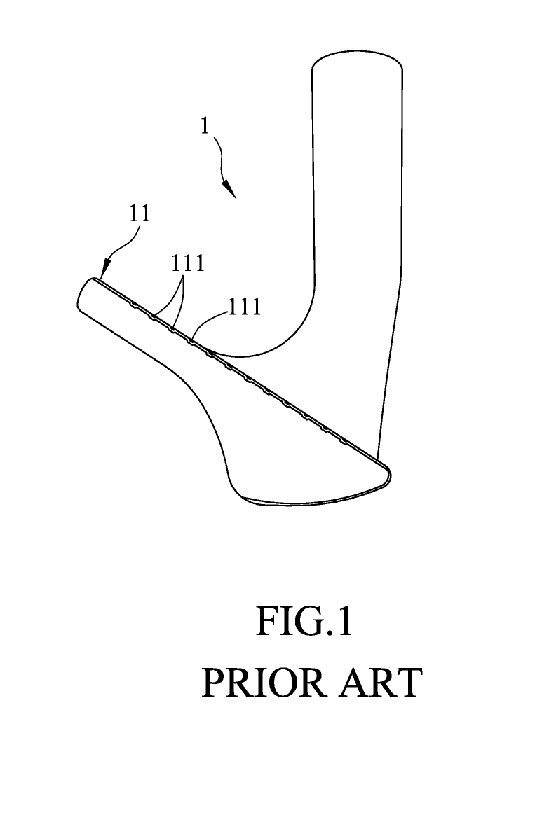

FIG. 2 illustrates consecutive steps of an embodiment of a method for manufacturing a striking plate for a golf club head according to the disclosure;

FIG. 3 is a top view of a striking plate of a golf club head manufactured by the method; and

FIG. 4 is a partial sectional view of the striking plate of the golf club head.

### DETAILED DESCRIPTION

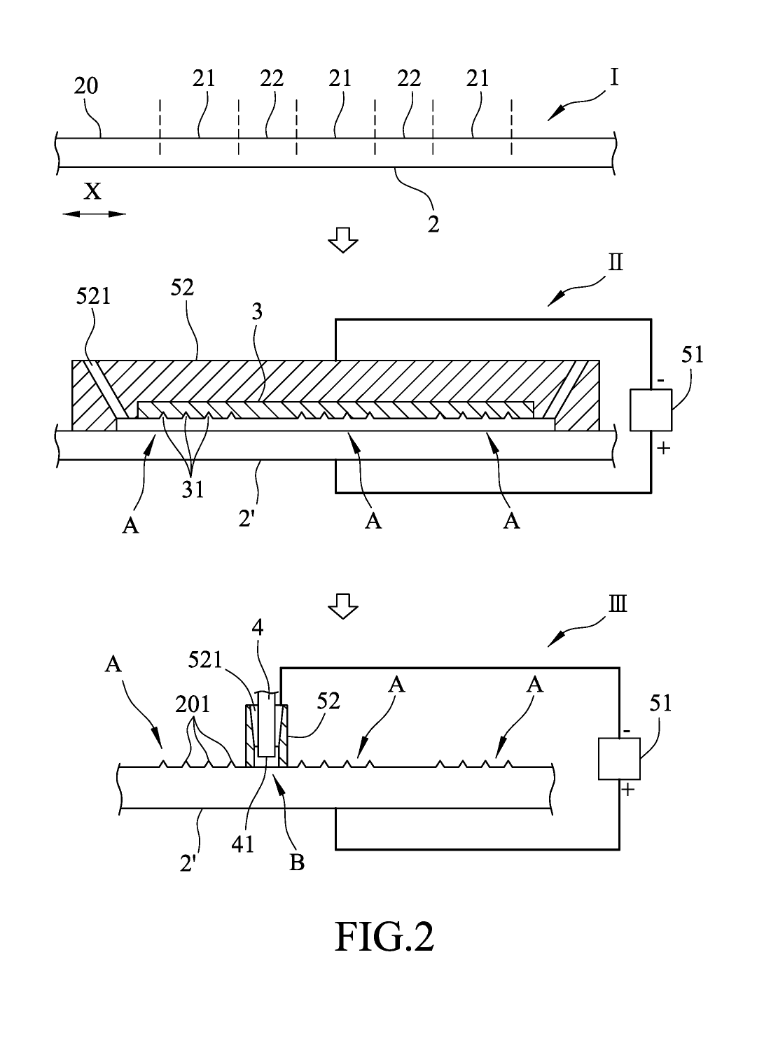

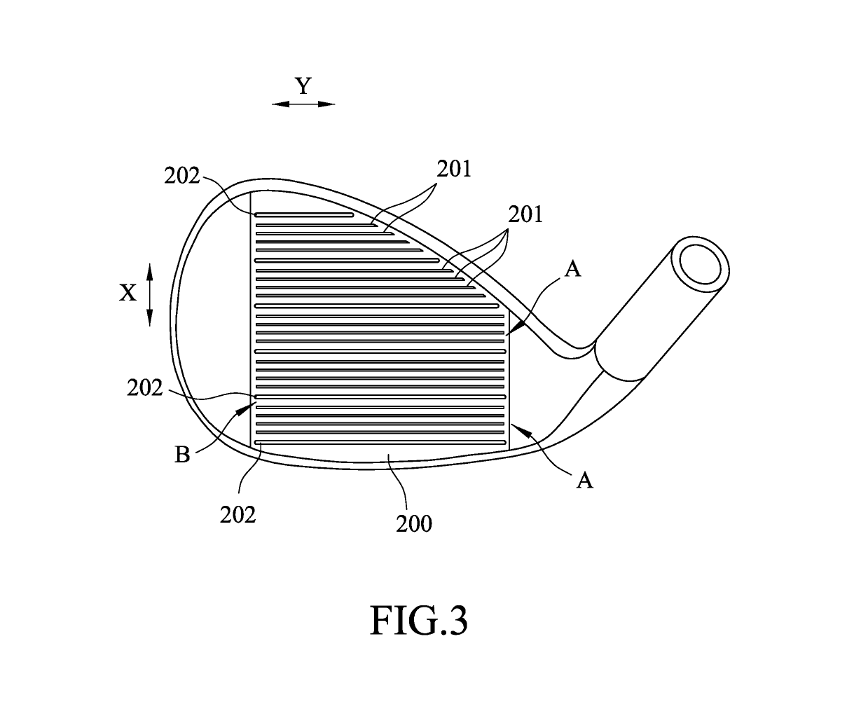

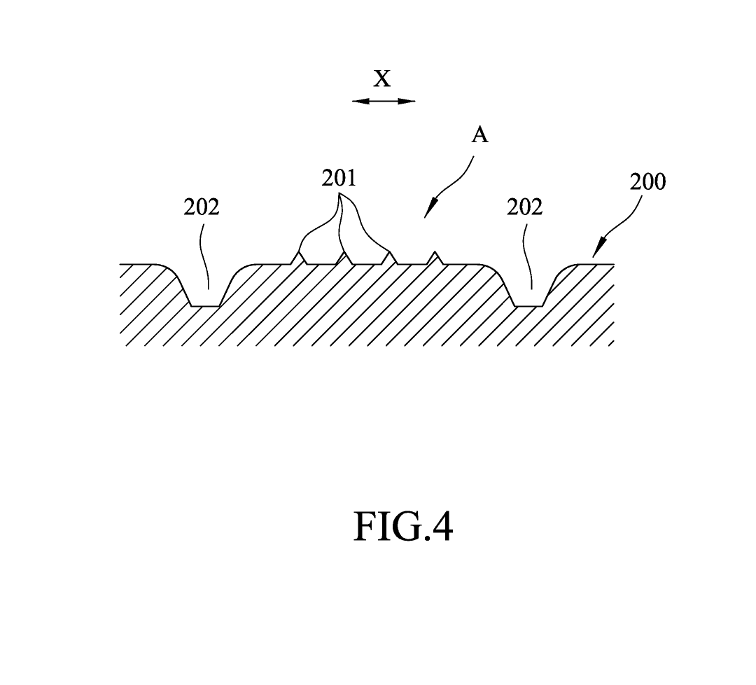

Referring to FIGS. 2, 3, and 4, an embodiment of a method for manufacturing a striking plate 200 for a golf club head according to the disclosure is shown to include the steps of: I) providing a metal blank plate 2, II) machining first machining zones 21 of the metal blank plate 2, and III) machining a semi-finished product 2′ obtained in step II).

In step I), the metal blank plate 2 provided has a surface 20 including a plurality of the first machining zones 21. The first machining zones 21 are displaced from each other in a first direction (X) by a corresponding one of a plurality of second machining zones 22. Each of the first machining zones 21 is intended to be formed with a first shaped area (A) having a plurality of parallel linear protrusions 201 which are displaced from each other in the first direction (X) by a predetermined distance and which extend in a second direction (Y) perpendicular to the first direction (X). Each of the second machining zones 22 is intended to be formed with a second shaped area (B) having a linear groove 202 extending in the second direction (Y).

In step II), the first machining zones 21 of the surface 20 of the metal blank plate 2 are machined using a precise electrochemical machining device which includes, as a cathode, a first template 3 having a plurality of linear recess portions 31 complementary in shape to the parallel linear protrusions 201 to be formed in the first machining zones 21 of the metal blank plate 2 to thereby obtain a semi-finished product 2′ formed with the parallel linear protrusions 201.

Each of the parallel linear protrusions 201 illustrated in FIG. 2 has a triangular cross section, and thus each of the linear recess portions 31 of the first template 3 is in the form of a triangular recess. In practical applications, each of the parallel linear protrusions 201 may have other geometrical cross sections, such as a rectangular, trapezoid, or semi-circular cross section, and thus each of the linear recess portions 31 of the first template 3 may be a complementary rectangular, trapezoid, or semi-circular triangular recess.

In step III), the semi-finished product 2′ is machined using the precise electrochemical machining device with the first template 3 replaced by a second template 4 that acts as the cathode and that has a protrusion portion 41 complementary in shape to the linear groove 202 to be formed in each of the second machining zones 22, thereby obtaining the striking plate 200.

In addition to the first and second templates 3, 4, the precise electrochemical machining device includes a power supply 51 and a grip 52 for gripping the first and second templates 3, 4. The grip 52 is provided with fluid passages 521.

It is noted that, instep II), the metal blank plate 2 acts as an anode, and that the first template 3 acting the cathode is advanced into the metal blank plate 2. An electrolytic fluid is then injected through the fluid passages 521 onto the surface 20 of the metal blank plate 2. As electrons cross a gap between the first template 3 and the metal blank plate 2 during an electrochemical reaction in step II) for machining the first machining zones 21, material from the metal blank plate 2 is dissolved in the electrolytic fluid to form the parallel linear protrusions 201 in the metal blank plate 2. Any metal hydroxide formed in step II) is carried away by the electrolytic fluid. The semi-finished product 2′ formed with the parallel linear protrusions 201 is thus obtained.

It is further noted that, in step III), the semi-finished product 2′ acts as the anode, and that the second template 4 acting the cathode is advanced into the semi-finished product 2′. The electrolytic fluid is injected through the fluid passages 521 onto a surface of the semi-finished product 2′. As electrons cross a gap between the second template 4 and the semi-finished product 2′ during an electrochemical reaction in step III) for machining the semi-finished product 2′, material from the semi-finished product 2′ is dissolved in the electrolytic fluid to form the linear grooves 202 in the semi-finished product 2′. Any metal hydroxide formed in step III) is carried away by the electrolytic fluid. The striking plate 200 for a golf club head is thus obtained.

In the method of the disclosure, as the parallel linear protrusions 201 may be formed simultaneously in step II), the processing time may be reduced, and problems such as thermal or mechanical stress associated with conventional mechanical processes maybe avoided. In addition, burrs will not be generated. Therefore, the precision of the striking plate 200 for a golf club head may be enhanced. Unlike conventional mechanical processes in which the mechanical machining tool is liable to wear, the templates 3, 4 of the precise electrochemical machining device for performing the method of the disclosure are relatively more durable because the method of the disclosure is non-mechanical. Thus, the cost for manufacturing the striking plate may be reduced.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for manufacturing a striking plate for a golf club head, comprising the steps of:
providing a metal blank plate having a surface which includes a plurality of first machining zones displaced from each other in a first direction by a corresponding one of a plurality of second machining zones, each of the first machining zones being intended to be formed with a first shaped area having a plurality of parallel linear protrusions displaced from each other in the first direction by a predetermined distance and extending in a second direction perpendicular to the first direction, each of the second machining zones being intended to be formed with a second shaped area having a linear groove extending in the second direction;
machining the first machining zones of the surface of the metal blank plate using a precise electrochemical machining device which includes, as a cathode, a first template having a plurality of linear recess portions complementary in shape to the parallel linear protrusions to be formed in the first machining zones of the metal blank plate that acts as an anode to thereby obtain a semi-finished product formed with the parallel linear protrusions; and
machining the semi-finished product that acts as the anode using the precise electrochemical device with the first template replaced by a second template that acts as the cathode and that has a protrusion portion complementary in shape to the linear groove to be formed in each of the second machining zones to thereby obtain the striking plate.
